(19) United States
(12) Patent Application Publication
(10) Pub. No.: US 2024/0163363 A1
(43) Pub. Date: May 16, 2024

(54) Selectively limiting functionality of a mobile terminal

(71) Applicant: Trevor J. Umback, New South Wales (AU)

(72) Inventor: Trevor J. Umback, New South Wales (AU)

(21) Appl. No.: 18/284,061

(22) PCT Filed: Mar. 23, 2022
(86) PCT No.: PCT/AU2022/050260

§ 371 Date: Sep. 25, 2023

(30) Foreign Application Priority Data
Mar. 23, 2021 (AU) 2021900860

(51) Int. Cl. H04M 1/72463; H04M 1/72457

(52) U.S. Cl. CPC H04M 1/72463; H04M 1/72457

(57) ABSTRACT

A method (400) of selectively limiting functionality of a mobile terminal MT (111), the method comprising the steps of: determining (401) a mobile terminal location MTL (522) of the mobile terminal MT (111); determining (605) a hazard rating at the location MTL (522) of the mobile terminal MT (111); enabling the mobile terminal MT (111) to operate in a full functionality mode if the determined hazard rating is at or less than an acceptable level; and enabling the mobile terminal MT (111) to operate in a limited functionality mode if the database determined hazard rating is above the acceptable level.

### FIELD OF THE INVENTION

The present invention relates generally to wireless communications and, in particular, to selectively limiting the functionality of a mobile communication terminal under certain conditions. The present invention also relates to a method and apparatus for selectively limiting the functionality of a mobile communication terminal, and to a computer program product including a computer readable medium having recorded thereon a computer program for selectively limiting the functionality of a mobile communication terminal.

The invention has been developed primarily with respect to a system and method for preventing collisions between a motor vehicle and a pedestrian and will be described hereinafter with reference to this application. However, it will be appreciated that the invention is not limited to this particular field of use.

### BACKGROUND OF THE INVENTION

Mobile communication terminals, such as (smart)phones, tablets, laptops and others have become ubiquitous in much of the world and use of such devices (referred to collectively hereinafter as “phones”) continues to increase. The use of such phones is very useful in many circumstances. However, use of phones under certain circumstances, such as when crossing a busy road for instance, poses a significant risk both for the user of the phone and people in the vicinity.

Current attempts to curb dangerous behaviour involving phones use include legal sanctions, such as fines imposed by police if a person uses a phone in particularly dangerous conditions, such as when driving without a hands-free phone arrangement. Such measures are only partially effective since detection of such behaviour is often not completely effective. Such measures can even aggravate the risks involved by encouraging people to attempt to obscure their phone by holding it between their thighs while driving, leading to reduced control of the vehicle.

Driving while a person is absorbed in using a phone is clearly extremely dangerous. However, although possibly less dangerous using a phone while walking also poses significant dangers both to the user of the phone (eg by tripping over an unseen obstacle or by walking into traffic without being aware of the circumstances) and to others, both pedestrians and drivers.

It will be appreciated that in some circumstances, an accident may occur as a result of a pedestrian, for example, moving in the path of a nearby vehicle whilst being distracted by a user terminal such as a cellular telephone or smartphone. It has been seen, in the example of pedestrians, that some disregard or ignore their obligations in law as pedestrians and are distracted directly causing an accident where they are impacted by the vehicle. Even at low speeds, significant damage can occur to the pedestrian. In such cases, and where there are no witnesses or video footage of an accident for example, it is not unknown for a vehicle driver to be considered at least partially responsible for the accident. The driver is then unfairly penalised financially and possibly with a traffic violation, notwithstanding the shock an innocent driver would feel in an accident where a person/s is injured and any damage they sustained in the accident. Clearly, this is also a problem for insurance equity and associated liability matters.

### SUMMARY OF THE INVENTION

It is an object of the present invention to substantially overcome, or at least ameliorate, one or more disadvantages of existing arrangements, or to provide a useful alternative.

Disclosed are arrangements, referred to as Selective Limitation of Mobile Communication (SLMC) arrangements, which seek to address the above problems by limiting the functionality of mobile terminals (MTs) when they are used in hazardous areas, and preferably as they are used by a user who is approaching a hazardous area.

According to a first aspect of the present invention, there is provided a method of selectively limiting functionality of a mobile terminal MT, the method comprising the steps of: determining a mobile terminal location MTL of the mobile terminal MT; determining a hazard rating at the location MTL of the mobile terminal MT; enabling the mobile terminal MT to operate in a full functionality mode if the determined hazard rating is at or less than an acceptable level; and enabling the mobile terminal MT to operate in a limited functionality mode if the determined hazard rating is above the acceptable level.

Preferably, in the method of paragraph the step of determining a mobile terminal location MTL of the mobile terminal MT further comprises the step of requesting a map overlay from a map database; and the step of determining a hazard rating at the location MTL of the mobile terminal MT further comprises the step of requesting a hazard overlay from a hazard database.

Optionally, in the method of paragraph the step of determining the hazard rating at the location MTL of the mobile terminal MT comprises the steps of: identifying the closest inherently hazardous area IHA to the mobile terminal MT; and if the mobile terminal location MTL is inside the identified inherently hazardous area IHA, specifying the hazard rating at the location MTL of the mobile terminal MT to be above the acceptable level.

Optionally, in the method of paragraph the step of determining the hazard rating at the location MTL of the mobile terminal MT comprises the steps of: identifying the closest inherently hazardous area IHA to the mobile terminal MT; determining a location of the closest point of the identified inherently hazardous area IHA to the mobile terminal Location (MTL); determining an inherent hazard rating IHR at the location of the closest point of the inherently hazardous area to the mobile terminal Location (MTL); determining a mobile terminal hazard velocity (MTHV) of the mobile terminal MT towards the location of the closest point of the inherently hazardous area to the mobile terminal Location (MTL); and determining the hazard rating at the location MTL of the mobile terminal MT dependent upon the location MTL of the mobile terminal MT and the mobile terminal hazard velocity (MTHV) of the mobile terminal MT.

According to another aspect of the present invention, there is provided a system for selectively limiting functionality of a mobile terminal MT, the system comprising: a server having a processor for executing a computer executable software program; one or more mobile terminals MT each having a processor for executing a computer executable software program; wherein the server and the one or more mobile terminals MT communicate over a communications network; and wherein the server and the one or more mobile terminals MT communicating over a communications network perform a method of selectively limiting functionality of the mobile terminal MT, the method comprising the steps of: determining a mobile terminal location MTL of the mobile terminal MT; determining a hazard rating at the location MTL of the mobile terminal MT; enabling the mobile terminal MT to operate in a full functionality mode if the determined hazard rating is at or less than an acceptable level; and enabling the mobile terminal MT to operate in a limited functionality mode if the determined hazard rating is above the acceptable level.

According to another aspect of the present invention, there is provided a computer executable software program for directing one or more processors to perform a perform a method of selectively limiting functionality of the mobile terminal MT, the method comprising the steps of: determining a mobile terminal location MTL of the mobile terminal MT; determining a hazard rating at the location MTL of the mobile terminal MT; enabling the mobile terminal MT to operate in a full functionality mode if the determined hazard rating is at or less than an acceptable level; and enabling the mobile terminal MT to operate in a limited functionality mode if the determined hazard rating is above the acceptable level.

Other aspects are also disclosed and it can be seen that preferred embodiments of the invention advantageously provided a method, system and apparatus for selectively limiting the functioning of a mobile terminal depending on location and a predetermined hazard rating associated with the area. Furthermore, the system and method can engage specific or complete mobile terminal functionality subject to location and/or hazard rating of the mobile terminal, and can also control mobile terminal functionality when in a vehicle whether the mobile terminal is secured in a holder. Yet further, it will be appreciated a mobile terminal will include a record or log of functionality of the mobile terminal including operation of the method of the first aspect as a function of distance and/or time offering useful legal records in the event of an accident or traffic violation.

### BRIEF DESCRIPTION OF THE DRAWINGS

Preferred embodiments of the invention will now be described, by way of example only, with reference to the accompanying drawings in which:

FIG. 1 depicts a hazard situation which the disclosed SLMC arrangement aims to prevent or at least ameliorate;

FIGS. 2A and 2B form a schematic block diagram of a general-purpose computer system upon which SLMC arrangements described can be practiced;

FIG. 3 is a flow diagram of one example of a server-centric method of performing a first SLMS arrangement according to the present disclosure;

FIG. 4 is a flow diagram of one example of a mobile terminal-centric method of performing the first SLMS arrangement according to the present disclosure;

FIG. 5A illustrates an example of a map overlay depicting a region in which the disclosed SLMC arrangement can be used to control functionality of a mobile terminal;

FIG. 5B shows the map overlay of FIG. 5A overlaid with numerous mobile terminals and buffer distance markings.

FIG. 6 is a flow chart on one example of a method for performing the step 317 in FIG. 3 and the step 417 in FIG. 4;

FIG. 7 shows the map overlay of FIG. 5 overlaid with hazard ratings and buffer distances; and

FIG. 8 is a flow diagram of one example of a mobile terminal-centric method of performing the second SLMS arrangement according to the present disclosure.

### DESCRIPTION OF THE PREFERRED EMBODIMENTS

Where reference is made in any one or more of the accompanying drawings to steps and/or features, which have the same reference numerals, those steps and/or features have for the purposes of this description the same function(s) or operation(s), unless the contrary intention appears. For the avoidance of doubt, like reference numerals are used to denote like components &/or steps.

It is to be noted that the discussions contained in the “Background” section and the section above relating to prior art arrangements relate to discussions of arrangements which may form public knowledge through their use. Such discussions should not be interpreted as a representation by the inventor or the patent applicant(s) that such arrangements in any way form part of the common general knowledge in the art.

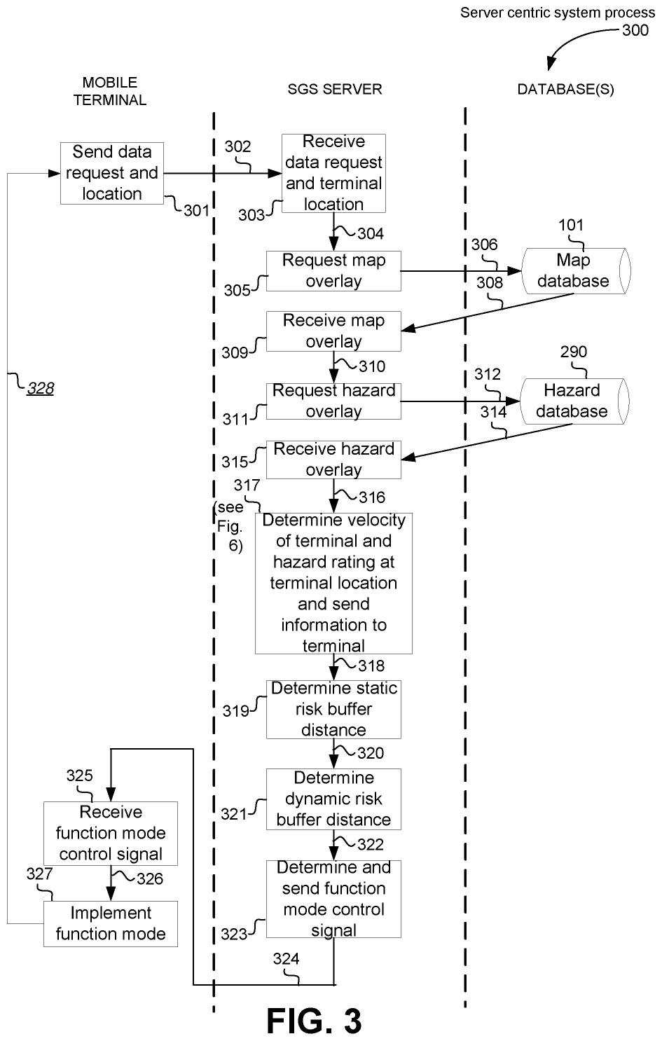

GLOSSARY OF TERMS

| No. | Term | Description |
|---|---|---|
| 1 | Acceptable | An acceptable level at which it is deemed to be safe enough to |
| | neighbouring | provide full functionality to the MT (ie enabling the MT to operate |
| | hazard rating | in full functionality mode FFM) |
| | (ANHR) | |
| 2 | Dynamic risk | The minimum distance a moving MT must be (while moving |
| | buffer distance | towards the inherently hazardous area at a mobile terminal hazard |
| | (DRBD) | velocity) from the boundary between the neighbouring hazard |
| | | area and the inherently hazardous area to be considered safe |
| | | enough to provide place the MT in full functionality mode - this is |
| | | a function of hazard ratings, Mobile terminal hazard velocity |
| | | (MTHV), and number N of required Polling Cycle Times (PCT) |
| 3 | Full functionality | An operating mode within which the MT is able to perform all |
| | mode (FFM) | functions for which the MT is designed. Thus, for example, if the |
| | | MT is a smart phone FFM might include making and receiving |
| | | telephone calls, text messaging (SMS—Short Message Service). |
| | | accessing Web pages and browsing the Web using 4G and 3G |
| | | data networks and Wi-Fi support, mobile broadband, near field |
| | | communication and Bluetooth, sending emails and syncing with |
| | | multiple email accounts, viewing, editing and sharing documents, |
| | | downloading files, creating and playing music playlists, taking |
| | | photos and recording videos, Global Positioning System (GPS) |
| | | functionality. |
| 4 | Functionality | A control signal which is sent to the MT in order to set the |
| | Mode Control | functionality mode of the MT as FFM or LFM. |
| | Signal (FMCS) | |
| 5 | Inherently | An area which is hazardous throughout its extent by virtue of a |
| | hazardous area | quality of the area itself |
| | (IHA) | |
| 6 | Inherent hazard | A quantitative measure of the danger associated with a specified |
| | rating (IHR) | location within an inherently hazardous area |
| 7 | Limited | An operating mode within which the MT is able to perform safety |
| | functionality | related functions and notifications as well as making calls to |
| | mode (LFM) | emergency services. Thus, for example, if the MT is a smart |
| | | phone LFM might be limited to making and receiving telephone |
| | | calls to/from emergency services only. |
| 8 | Mobile terminal | A device which communicates wirelessly over a communication |
| | (MT) | network, such devices including smart phones, tablets, laptop |
| | | computers |
| 9 | Mobile Terminal | The distance of the MT location from the boundary between the |
| | Hazard | neighbouring hazard area and the inherently hazardous area |
| | Distance | |
| | (MTHD) | |
| 10 | Mobile terminal | The component of the velocity vector (MTV) of a MT, located in a |
| | hazard velocity | neighbouring hazardous area, towards the associated inherently |
| | (MTHV) | hazardous area |
| 11 | Mobile terminal | The distance travelled by the MT, moving at Mobile terminal |
| | hazard velocity | hazard velocity (MTHV) for N Polling Cycle Times (PCT) where |
| | distance | N >= 2 |
| | (MTHVD) | |
| 12 | Mobile Terminal | The geographic location of the MT in coordinates such as those |
| | Location (MTL) | provided by the Global Positioning System (GPS) |
| 13 | Mobile Terminal | The velocity vector (MTV) of an MT |
| | Velocity (MTV) | |
| 14 | Neighbouring | An area which is hazardous by virtue of its proximity to an |
| | hazardous area | inherently hazardous area |
| | (NHA) | |
| 15 | Neighbouring | A quantitative measure of the danger associated with a specified |
| | hazard rating | location within a neighbouring hazardous area |
| | (NHR) | |
| 16 | Neighbouring | A measure of how a value of the neighbouring hazard rating |
| | hazard rating | changes in a neighbouring hazardous area dependent upon a |
| | attenuation | distance Dh from the boundary between the neighbouring hazard |
| | factor (NHRAF) | area and the inherently hazardous area |
| 17 | Polling Cycle | The time required for the SLMC arrangement to update all system |
| | Time (PCT) | data according to any of FIGS. 3, 4, 6, 8 |
| 18 | Predetermined | A distance over which the location (MTL) of the MT is measured |
| | distance (PD) | during a predetermined time (PT) to determine the velocity (MTV) |
| | | of the MT |
| 19 | Predetermined | A predetermined time period during which the location (MTL) of |
| | time (PT) | the MT is measured to determine the velocity (MTV) of the MT |
| 20 | Static risk buffer | The minimum distance a stationary MT must be from the |
| | distance | boundary between the neighbouring hazard area and the |
| | (SRBD) | inherently hazardous area to be considered safe enough to place |
| | | the MT in full functionality mode - this is a function of hazard |
| | | ratings only |

As noted, the disclosed SLMC arrangements are wide scale safety systems for the general public which regulate and remove or at least reduce the “distraction” of smart phones and other mobile computing devices (referred to as mobile terminals or MTs) while people are located in (or near) hazardous areas (including both inherently hazardous areas IHA and neighbouring hazardous areas NHA), including “trafficable zones”.

In the disclosed SLMC arrangements, MTs can operate in full functionality mode (FFM) or limited functionality mode (LFM). The SLMC arrangements reduce or eliminate distraction by limiting mobile terminal functionality (ie causing the MT to transition from FFM to LFM) based on the determined risk to the user of the MT and/or others. This risk is determined based on a number of factors, including the geo-location (MTL) of the MT, the hazard rating (IHR, NHR) assigned to that particular geo-location at that time (real-time or scheduled) and whether the MT is detected to be moving. If the risk is greater than a predetermined threshold (ANHR), then some mobile terminal functions are disabled (by causing the MT to transition from FFM to LFM) until the risk falls below the predetermined risk threshold (ANHR).

The SLMC arrangements use the following pieces of information among others:
a. Geo-location (MTL) of the mobile terminal;
b. Map data identifying inherently hazardous/trafficable areas (IHA) and neighbouring hazardous areas (NHA);
c. The hazard rating (IHR) for inherently hazardous areas and hazard ratings (NHR) for neighbouring hazardous areas at that particular time;
d. Whether movement of the mobile terminal is detected beyond a predetermined distance (PD) over a predetermined time period (PT). Since the accuracy of geo-location using, for example, GPS alone, is affected by buildings (which can reflect and shadow GPS signals), a larger movement threshold (ie a greater PD measured over a larger PT) may be necessary within inner-city built environments.).

Creating and maintaining a meta-layer “map” of hazardous/trafficable areas is performed in consultation with local government bodies and/or other responsible entities. The hazard rating (IHR, NHR) assigned to a particular geo-location at any time can, for example, be pre-programmed according to scheduled traffic in the case of a shared-use zone or an increase in hazards at night. Alternatively, the hazard rating (IHR, NHR) for the geo-location can be assigned based on real-time data (e.g. from vehicle sensors, pedestrian counters or environmental sensors). Since the geo-location (MTL) of mobile terminal is being constantly monitored, should the mobile terminal be detected as being either in or too near to an inherently hazardous area (IHA), the mobile terminal is automatically placed into a “limited function” mode. This predefined limited function mode effects safety by limiting distractions through the user viewing and/or interacting with the mobile terminal while retaining important device safety-related functionality.

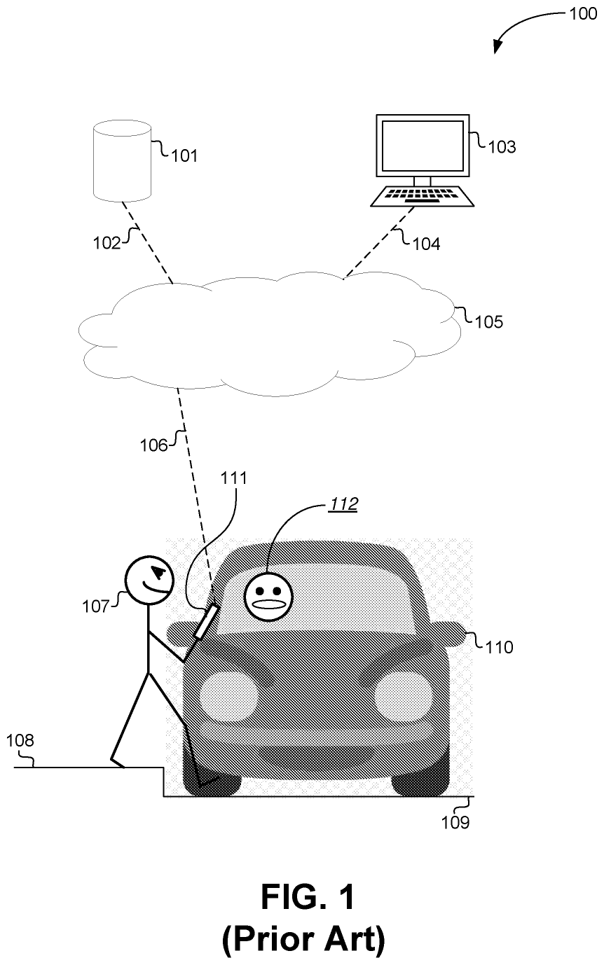

The implementation of the SLMC arrangements is best achieved by the operating system of the mobile terminal MT in conjunction with a remote server and appropriate meta-layer maps stored in remote databases (described hereinafter in more detail with reference to FIG. 1). The operating system of the mobile terminal limits the control of software applications executing on the mobile terminal such that a third-party application cannot otherwise re-enable the full function of the mobile terminal. The behaviour of mobile terminal operating systems are typically controlled by Apple (iOS) and Google (Android).

FIG. 1 depicts a hazard situation which the disclosed SLMC arrangement aims to prevent or at least ameliorate. A person 107 is walking on a sidewalk 108 while looking at his MT 111 (the term “mobile terminal” is used throughout the specification, however the disclosed SLMC arrangement can operate if the person is using any type of mobile terminal device including smart-phones, laptop computers, tablets or the like). The person 107 is about to step off the sidewalk 108 (which is a neighbouring hazardous area NHA) onto a road 109 (which is an inherently hazardous area IHA) and is unaware of an oncoming vehicle 110. This all too common situation can lead to serious injury or worse for the person 107 and/or the driver 112 of the vehicle 110 and/or other people (not shown) in the vicinity.

The disclosed SLMC arrangement aims to eliminate or at least ameliorate the risk by regulating and removing the “distraction” presented by the MT 111 while the person 107 is located in (or near) inherently hazardous areas IHA, including “trafficable zones” such as the road 109. More particularly, in the disclosed SLMC arrangement should the MT 111, while in operation, be detected as being in or near the inherently hazardous area IHA 109, the MT 111 automatically enters a safer “limited function” mode LFM under control of the operating system 268 of the MT 111 operating in conjunction with (a) an SLMC server 103, (b) relevant information in the one or more databases 101, and (c) a communication network 105. This limited function mode would effect safety by limiting distractions through the user 107 viewing and/or interacting with the MT 111 while retaining important device safety-related functionality.

The operating system 268 of the MT 111 communicates over the communication network 105 with the server 103 as depicted by dashed lines 106, 104. The server 103 communicates with the databases 101 over the communications network 105 as depicted by dashed lines 104, 102.

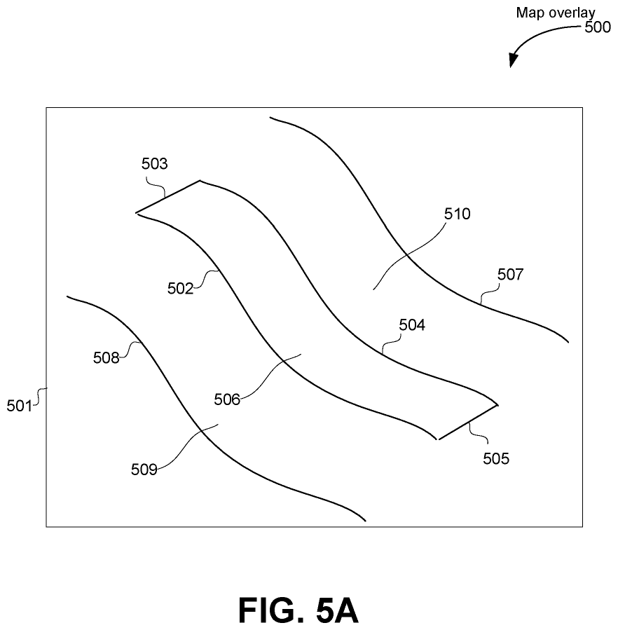

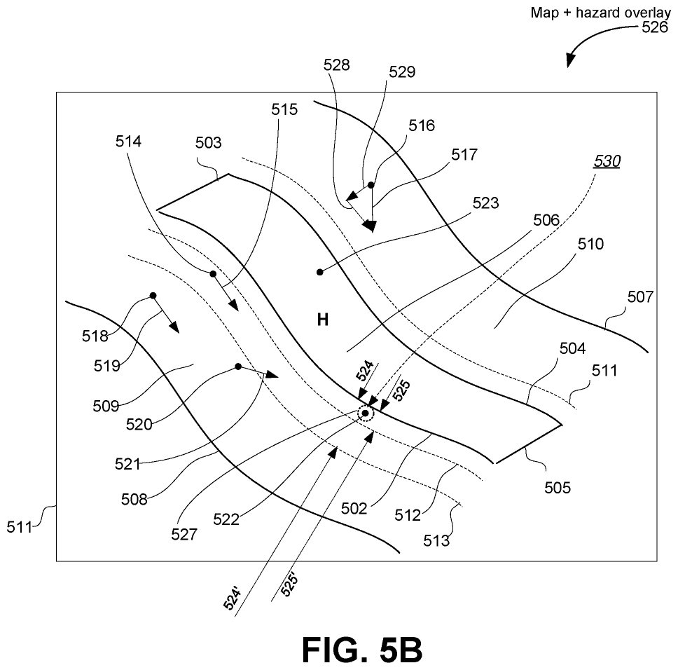

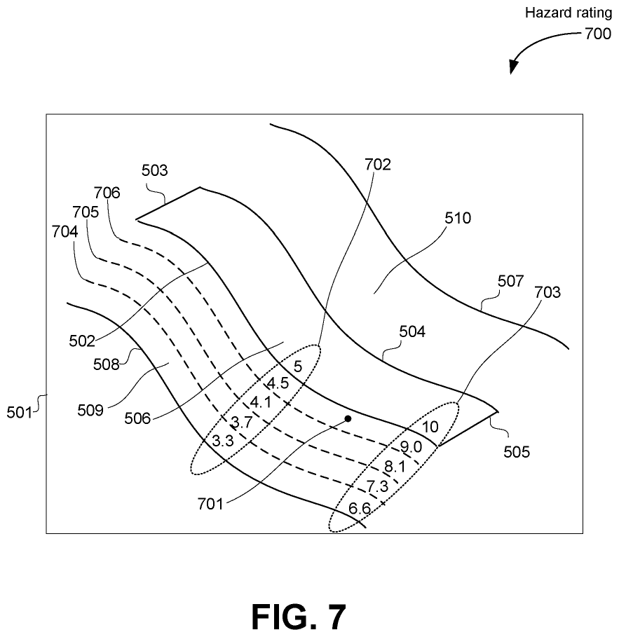

The operating system 268 of the mobile terminal 111 constantly monitors the location MTL (eg see 522 in FIG. 5B) of the mobile terminal MT 111 and compares the location MTL with the map of hazardous areas (described hereinafter in more detail with reference to FIGS. 5A, 5B and 7). If the mobile terminal MT is inside (eg see 523 in FIG. 5B) an inherently hazardous area IHA, the operating system 268 of the mobile terminal 111 enters a limited functionality mode LFM, thereby protecting both the user and others from potential harm through distraction and inattention to hazards. If the mobile terminal 111 is inside a neighbouring hazardous area NHA and the neighbouring hazard rating NHR exceeds a predefined acceptable neighbouring hazard rating ANHR, the operating system 268 of the mobile terminal 111 enters a limited functionality mode LFM, thereby protecting both the user and others from potential harm through distraction and inattention to hazards.

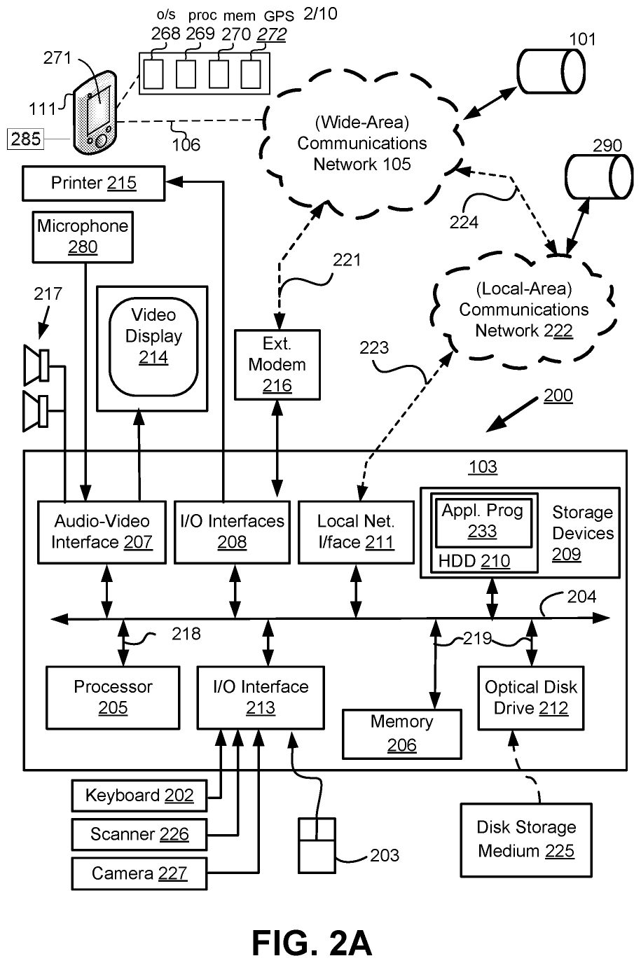

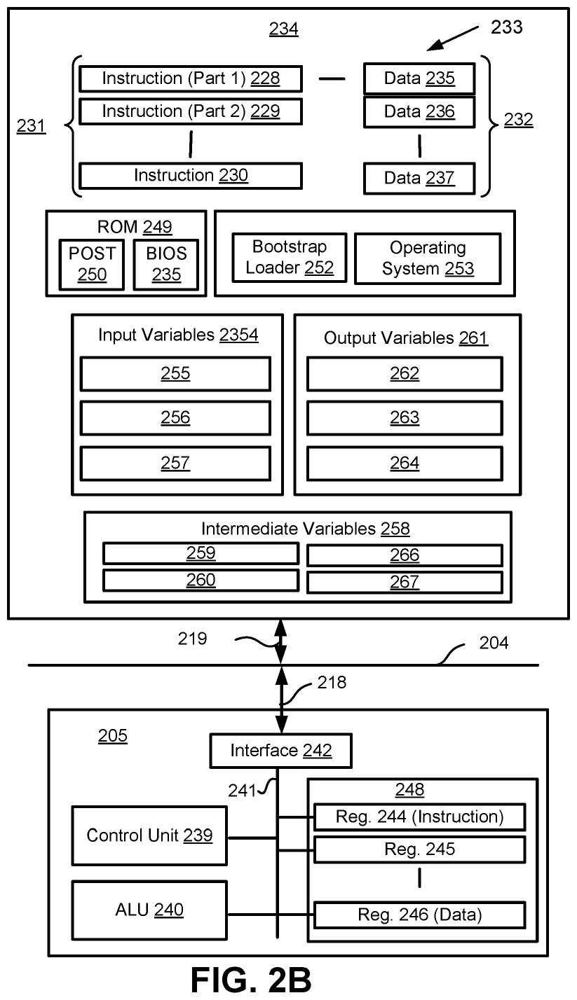

FIGS. 2A and 2B form a schematic block diagram of a general-purpose computer system upon which SLMC arrangements described can be practiced FIGS. 2A and 2B depict a general-purpose computer system 200, upon which the various arrangements described can be practiced. Although the following detailed description relates primarily to the server 103, it applies mutatis mutandis to operation of the mobile terminal(s) 111.

As seen in FIG. 2A, the computer system 200 includes: a computer module being the server 103; input devices such as a keyboard 202, a mouse pointer device 203, a scanner 226, a camera 227, and a microphone 280; and output devices including a printer 215, a display device 214 and loudspeakers 217. An external Modulator-Demodulator (Modem) transceiver device 216 may be used by the computer module 103 for communicating to and from the mobile terminal 111 and the remote database 101 over the communications network 105 via a connection 221. The communications network 105 may be a wide-area network (WAN), such as the Internet, a cellular telecommunications network, or a private WAN. Where the connection 221 is a telephone line, the modem 216 may be a traditional “dial-up” modem. Alternatively, where the connection 221 is a high capacity (e.g., cable) connection, the modem 216 may be a broadband modem. A wireless modem may also be used for wireless connection to the communications network 105.

The computer module 103 typically includes at least one processor unit 205, and a memory unit 206. For example, the memory unit 206 may have semiconductor random access memory (RAM) and semiconductor read only memory (ROM). The computer module 103 also includes an number of input/output (I/O) interfaces including: an audio-video interface 207 that couples to the video display 214, loudspeakers 217 and microphone 280; an I/O interface 213 that couples to the keyboard 202, mouse 203, scanner 226, camera 227 and optionally a joystick or other human interface device (not illustrated); and an interface 208 for the external modem 216 and printer 215. In some implementations, the modem 216 may be incorporated within the computer module 103, for example within the interface 208. The computer module 103 also has a local network interface 211, which permits coupling of the computer system 200 via a connection 223 to a local-area communications network 222, known as a Local Area Network (LAN). As illustrated in FIG. 2A, the local communications network 222 may also couple to the wide network 105 via a connection 224, which would typically include a so-called “firewall” device or device of similar functionality. The local network interface 211 may comprise an Ethernet circuit card, a Bluetooth® wireless arrangement or an IEEE 802.11 wireless arrangement; however, numerous other types of interfaces may be practiced for the interface 211.

The I/O interfaces 208 and 213 may afford either or both of serial and parallel connectivity, the former typically being implemented according to the Universal Serial Bus (USB) standards and having corresponding USB connectors (not illustrated). Storage devices 209 are provided and typically include a hard disk drive (HDD) 210. Other storage devices such as a floppy disk drive and a magnetic tape drive (not illustrated) may also be used. An optical disk drive 212 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 200.

The components 205 to 213 of the computer module 103 typically communicate via an interconnected bus 204 and in a manner that results in a conventional mode of operation of the computer system 200 known to those in the relevant art. For example, the processor 205 is coupled to the system bus 204 using a connection 218. Likewise, the memory 206 and optical disk drive 212 are coupled to the system bus 204 by connections 219. Examples of computers on which the described arrangements can be practised include IBM-PC's and compatibles, Sun Sparcstations, Apple Mac™ or like computer systems.

The SLMC method may be implemented using the computer system 200 wherein the processes of FIGS. 3, 4, 6 and 8 to be described, may be implemented as one or more software application programs 233, 268 executable within the computer system 200. In particular, the steps of the SLMC method are effected by instructions 231 (see FIG. 2B) in the software 233, 268 that are carried out within the computer system 200. The software instructions 231 may be formed as one or more code modules, each for performing one or more particular tasks. The software may also be divided into two separate parts, in which a first part and the corresponding code modules performs the SLMC methods and a second part and the corresponding code modules manage a user interface between the first part and the user.

The software may be stored in a computer readable medium, including the storage devices described below, for example. The software is loaded into the computer system 200 from the computer readable medium, and then executed by the computer system 200. A computer readable medium having such software or computer program recorded on the computer readable medium is a computer program product. The use of the computer program product in the computer system 200 preferably effects an advantageous SLMC apparatus.

The software 233, 268 is typically stored in the HDD 210 or the memory 206 in the server 103 and in the memory module 270 in the mobile terminal 111. The software is loaded into the computer system 200 from a computer readable medium, and executed by the computer system 200. Thus, for example, the software 233, 268 may be stored on an optically readable disk storage medium (e.g., CD-ROM) 225 that is read by the optical disk drive 212. A computer readable medium having such software or computer program recorded on it is a computer program product. The use of the computer program product in the computer system 200 preferably effects an SLMC apparatus.

In some instances, the application programs 233, 268 may be supplied to the user encoded on one or more CD-ROMs 225 and read via the corresponding drive 212, or alternatively may be read by the user from the networks 105 or 222. Still further, the software can also be loaded into the computer system 200 from other computer readable media. Computer readable storage media refers to any non-transitory tangible storage medium that provides recorded instructions and/or data to the computer system 200 for execution and/or processing. Examples of such storage media include floppy disks, magnetic tape, CD-ROM, DVD, Blu-Ray™ Disc, a hard disk drive, a ROM or integrated circuit, USB memory, a magneto-optical disk, or a computer readable card such as a PCMCIA card and the like, whether or not such devices are internal or external of the computer module 103. Examples of transitory or non-tangible computer readable transmission media that may also participate in the provision of software, application programs, instructions and/or data to the computer module 103 include radio or infra-red transmission channels as well as a network connection to another computer or networked device, and the Internet or Intranets including e-mail transmissions and information recorded on Websites and the like.

The second part of the application programs 233, 268 and the corresponding code modules mentioned above may be executed to implement one or more graphical user interfaces (GUIs) to be rendered or otherwise represented upon the display 214 of the server and the corresponding display 271 of the mobile terminal 111. Through manipulation of typically the keyboard 202 and the mouse 203, and the user interface of the mobile terminal 111, a user of the computer system 200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 217 and user voice commands input via the microphone 280.

The disclosed SLMC arrangements operate largely automatically, and typically the user of the mobile terminal has only cosmetic control such as display colour. The user of the mobile terminal 111 typically cannot disable the SLMC functionality.

FIG. 2B is a detailed schematic block diagram of the processor 205 and a “memory” 234. The memory 234 represents a logical aggregation of all the memory modules (including the HDD 209 and semiconductor memory 206) that can be accessed by the computer module 103 in FIG. 2A.

When the computer module 103 is initially powered up, a power-on self-test (POST) program 250 executes. The POST program 250 is typically stored in a ROM 249 of the semiconductor memory 206 of FIG. 2A. A hardware device such as the ROM 249 storing software is sometimes referred to as firmware. The POST program 250 examines hardware within the computer module 103 to ensure proper functioning and typically checks the processor 205, the memory 234 (209, 206), and a basic input-output systems software (BIOS) module 251, also typically stored in the ROM 249, for correct operation. Once the POST program 250 has run successfully, the BIOS 251 activates the hard disk drive 210 of FIG. 2A. Activation of the hard disk drive 210 causes a bootstrap loader program 252 that is resident on the hard disk drive 210 to execute via the processor 205. This loads an operating system 253, 268 into the RAM memory 206, upon which the operating system 253, 268 commences operation. The operating system 253, 268 is a system level application, executable by the processors 205, 269 to fulfil various high level functions, including processor management, memory management, device management, storage management, software application interface, generic user interface and the SLMC arrangement.

The operating system 253 manages the memory 234 (209, 206) to ensure that each process or application running on the computer module 103 has sufficient memory in which to execute without colliding with memory allocated to another process. Furthermore, the different types of memory available in the system 200 of FIG. 2A must be used properly so that each process can run effectively. Accordingly, the aggregated memory 234 is not intended to illustrate how particular segments of memory are allocated (unless otherwise stated), but rather to provide a general view of the memory accessible by the computer system 200 and how such is used.

As shown in FIG. 2B, the processor 205 includes a number of functional modules including a control unit 239, an arithmetic logic unit (ALU) 240, and a local or internal memory 248, sometimes called a cache memory. The cache memory 248 typically includes a number of storage registers 244-246 in a register section. One or more internal busses 241 functionally interconnect these functional modules. The processor 205 typically also has one or more interfaces 242 for communicating with external devices via the system bus 204, using a connection 218. The memory 234 is coupled to the bus 204 using a connection 219.

The application program 233, 268 includes a sequence of instructions 231 that may include conditional branch and loop instructions. The program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, the processor 205 is given a set of instructions which are executed therein. The processor 205 waits for a subsequent input, to which the processor 205 reacts to by executing another set of instructions. Each input may be provided from one or more of a number of sources, including data generated by one or more of the input devices 202, 203, data received from an external source across one of the networks 105, 202, data retrieved from one of the storage devices 206, 209 or data retrieved from a storage medium 225 inserted into the corresponding reader 212, all depicted in FIG. 2A. The execution of a set of the instructions may in some cases result in output of data. Execution may also involve storing data or variables to the memory 234.

The disclosed SLMC arrangements use input variables 254, which are stored in the memory 234 in corresponding memory locations 255, 256, 257. The SLMC arrangements produce output variables 261, which are stored in the memory 234 in corresponding memory locations 262, 263, 264. Intermediate variables 258 may be stored in memory locations 259, 260, 266 and 267.

Referring to the processor 205 of FIG. 2B, the registers 244, 245, 246, the arithmetic logic unit (ALU) 240, and the control unit 239 work together to perform sequences of micro-operations needed to perform “fetch, decode, and execute” cycles for every instruction in the instruction set making up the program 233. Each fetch, decode, and execute cycle comprises:
a fetch operation, which fetches or reads an instruction 231 from a memory location 228, 229, 230;
a decode operation in which the control unit 239 determines which instruction has been fetched; and
an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

Each step or sub-process in the processes of FIGS. 3, 4, 6 and 8 is associated with one or more segments of the program 233, 268 and is performed by the register section 244, 245, 247, the ALU 240, and the control unit 239 in the processor 205 (as well as the processor 269, operating system 268 and memory 270 of the mobile terminal 111) working together to perform the fetch, decode, and execute cycles for every instruction in the instruction set for the noted segments of the program 233.

While stationary or moving within inherently hazardous areas IHA, functionality of the mobile terminal MT is controlled to enter the limited functionality mode LFM in which the MT is limited to predefined functions such as safety related functions and notifications as well as making calls to emergency services.

A number of mode transition examples are detailed in the table below.

MODE TRANSITION EXAMPLES

| Current state | Next state |
|---|---|
| MT is stationary or moving in Inherently hazardous | MT remains in/transitions to |
| area (IHA) | Limited Functionality Mode (LFM) |
| MT is stationary in Neighbouring Hazardous Area | MT remains in/transitions to |
| (NHA) and MT Neighbouring Hazard Rating (NHR) is | Full Functionality |
| less than Acceptable neighbourhood hazard rating | Mode (FFM) |
| (ANHR) | |
| MT is in Neighbouring Hazardous Area (NHA) moving | MT remains in/transitions to |
| at a Mobile terminal hazard velocity (MTHV) sufficient | Limited Functionality |
| to result in Neighbourhood Hazard Rating (NHR) | Mode (LFM) |
| exceeding Acceptable neighbourhood hazard rating | |
| (ANHR) in less that N Polling Cycle Times (PCT) where | |
| N > 1 | |
| MT is in Neighbouring Hazardous Area (NHA) moving | MT remains in/transitions to |
| at a Mobile terminal hazard velocity (MTHV) sufficient | Full Functionality |
| to result in Neighbourhood Hazard Rating (NHR) not | Mode (FFM) |
| exceeding Acceptable neighbourhood hazard rating | |
| (ANHR) in less that N Polling Cycle Times (PCT) where | |
| N > 1 | |
| MT is stationary and Mobile terminal location (MTL) is | MT remains in/transitions to |
| at greater distance than Static risk buffer distance | Full Functionality |
| (SRBD) from the boundary between the neighbouring | Mode (FFM) |
| hazard area and the inherently hazardous area | |
| MT is stationary and Mobile terminal location (MTL) is | MT remains in/transitions to |
| at less distance than Static risk buffer distance (SRBD) | Limited Functionality |
| from the boundary between the neighbouring hazard | Mode (LFM) |
| area and the inherently hazardous area | |
| MT is moving and Mobile terminal location (MTL) is at | MT remains in/transitions to |
| greater distance than Dynamic risk buffer distance | Full Functionality |
| (DRBD) from the boundary between the neighbouring | Mode (FFM) |
| hazard area and the inherently hazardous area | |
| MT is moving and Mobile terminal location (MTL) is at | MT remains in/transitions to |
| less distance than Dynamic risk buffer distance (DRBD) | Limited Functionality |
| from the boundary between the neighbouring hazard | Mode (LFM) |
| area and the inherently hazardous area | |

FIG. 3 is a flow diagram of one example of a server-centric method 300 of performing a first SLMS arrangement according to the present disclosure. A significant amount of the processing and storage resources for this process are provided by the server 103 rather than the mobile terminal 111. The process 300 commences a current polling cycle with a step 301, performed by the processor 269 of the mobile terminal 111 executing the operating system 268, which determines the Mobile terminal location (MTL) using an onboard GPS chip set 272 to communicate with a global positioning system satellite, for example, and communicates this MTL together with a request for data, to the SGS server 103. Control then follows an arrow 302 from the step 301 to a step 303, performed by the processor 205 of the server 103 executing the SLMC software application 233. The step 303, performed by the processor 205 of the server 103 executing the SLMC software application 233, receives the MTL and the data request, and control then follows an arrow 304 from the step 303 to a step 305.

The step 305, performed by the processor 205 of the server 103 executing the SLMC software application 233, requests as depicted by an arrow 306, a map overlay (described hereinafter in more detail with reference to FIG. 5) from the database 101. The database 101 then sends, as depicted by an arrow 308, the requested map overlay to a step 309. The step 309, performed by the processor 205 of the server 103 executing the SLMC software application 233, receives the map overlay, and control then follows an arrow 310 from the step 309 to a step 311. The step 311, performed by the processor 205 of the server 103 executing the SLMC software application 233, requests, as depicted by an arrow 312, a hazard overlay (described hereinafter in more detail with reference to FIG. 7) from the database 101. The database 101 then sends, as depicted by an arrow 314, the requested hazard overlay to a step 315. The step 315, performed by the processor 205 of the server 103 executing the SLMC software application 233, receives the hazard overlay, and control then follows an arrow 316 from the step 315 to a step 317.

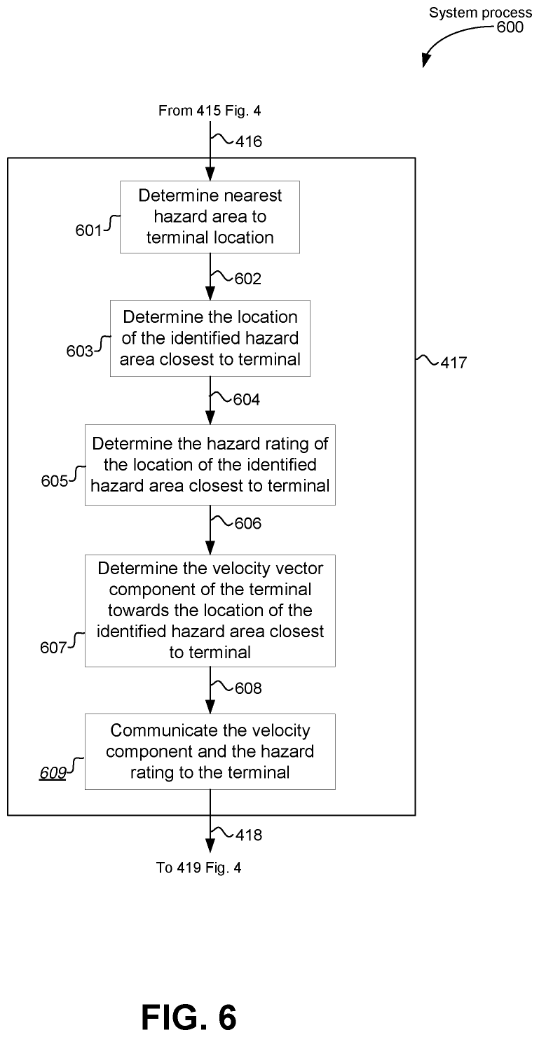

The step 317, performed by the processor 205 of the server 103 executing the SLMC software application 233 and described hereinafter in more detail with reference to FIG. 6, determines the Mobile terminal hazard velocity (MTHV) and the hazard rating at the Mobile terminal location (MTL), and control then follows an arrow 318 from the step 317 to a step 319. The step 319, performed by the processor 205 of the server 103 executing the SLMC software application 233, described hereinafter in more detail under the sub-heading “Determination of the Static Risk Buffer Distance (SRBD)”, determines the Static risk buffer distance (SRBD) for the mobile terminal 111, and control then follows an arrow 320 to a step 321. The step 321, performed by the processor 205 of the server 103 executing the SLMC software application 233, described hereinafter in more detail under the sub-heading “Determination of the Dynamic Risk Buffer Distance (MRBD)”, determines the Dynamic risk buffer distance (DRBD) for the mobile terminal 111, and control then follows an arrow 322 to a step 323.

The step 323, performed by the processor 205 of the server 103 executing the SLMC software application 233, determines the Functionality mode control signal (FMCS) and send the signal to the mobile terminal, and control then follows an arrow 324 to a step 325. If the MTL of the MT is at a distance from the boundary between the neighbouring hazard area and the inherently hazardous area which is greater than the Static Risk Buffer Distance (SRBD) and greater than the Dynamic Risk Buffer Distance (MRBD) then the step 323 sends a Functionality Mode Control Signal (FMCS) to the MT for setting the functionality of the MT to Full functionality mode (FFM). If however the MTL of the MT is at a distance from the boundary between the neighbouring hazard area and the inherently hazardous area which is less than the Static Risk Buffer Distance (SRBD) and less than the Dynamic Risk Buffer Distance (MRBD) then the step 323 sends a Functionality Mode Control Signal (FMCS) to the MT for setting the functionality of the MT to Limited functionality mode (LFM).

The step 325, performed by the processor 269 of the mobile terminal 111 executing the operating system 268, receives the Functionality mode control signal (FMCS) and control then follows and arrow 326 to a step 327. The step 327, performed by the processor 269 of the mobile terminal 111 executing the operating system 268, directs the operating system 268 of the mobile terminal to adopt the appropriate functionality mode, ie either the Full functionality mode (FFM) or the Limited functionality mode (LFM). Control then follows an arrow 328 back to the step 301, and this completes the current polling cycle taking an average Polling cycle time (PCT) to complete the entire cycle.

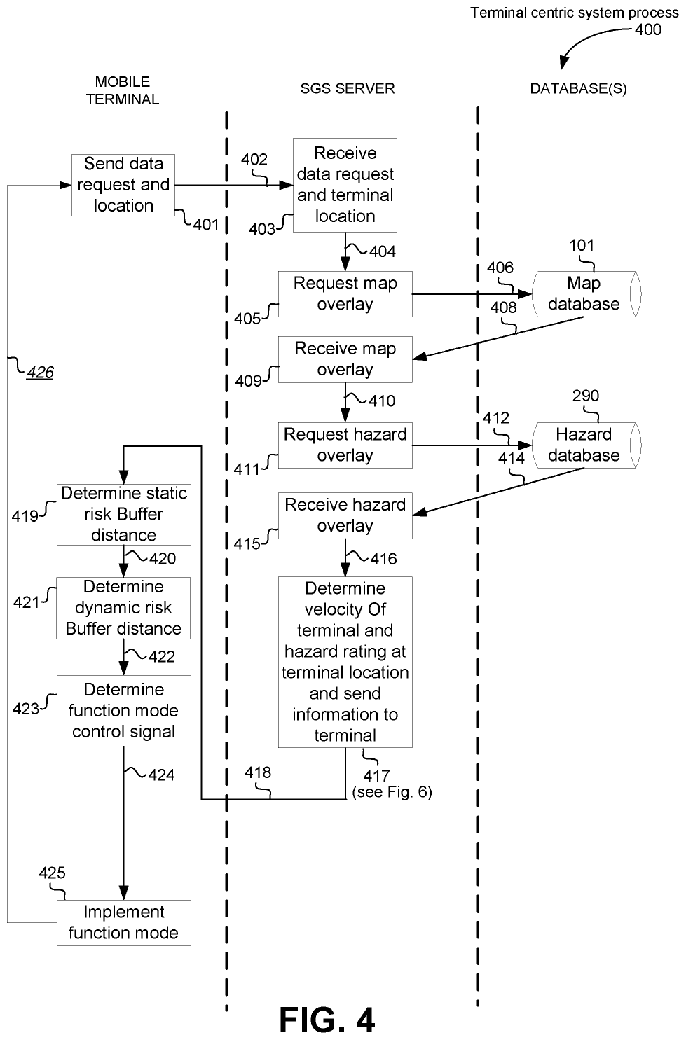

FIG. 4 is a flow diagram of one example of a mobile terminal-centric method of performing the first SLMS arrangement according to the present disclosure. More processing and storage resources for this process are provided by the mobile terminal 111 than in the process 300 in FIG. 3. The process 400 commences a current polling cycle with a step 401, performed by the processor 269 of the mobile terminal 111 executing the operating system 268, which determines the Mobile terminal location (MTL) using an onboard GPS chip set 272 to communicate with a global positioning system satellite, for example, and communicates this MTL together with a request for data, to the SGS server 103. Control then follows an arrow 402 from the step 401 to a step 403, performed by the processor 205 of the server 103 executing the SLMC software application 233. The step 403, performed by the processor 205 of the server 103 executing the SLMC software application 233, receives the MTL and the data request, and control then follows an arrow 404 from the step 403 to a step 405.

The step 405, performed by the processor 205 of the server 103 executing the SLMC software application 233, requests as depicted by an arrow 406, a map overlay (described hereinafter in more detail with reference to FIG. 5) from the database 101. The database 101 then sends, as depicted by an arrow 408, the requested map overlay to a step 409. The step 409, performed by the processor 205 of the server 103 executing the SLMC software application 233, receives the map overlay, and control then follows an arrow 410 from the step 409 to a step 411. The step 411, performed by the processor 205 of the server 103 executing the SLMC software application 233, requests, as depicted by an arrow 412, a hazard overlay (described hereinafter in more detail with reference to FIG. 7) from a hazard database 290. The database 101 then sends, as depicted by an arrow 414, the requested hazard overlay to a step 415. The step 415, performed by the processor 205 of the server 103 executing the SLMC software application 233, receives the hazard overlay, and control then follows an arrow 416 from the step 415 to a step 417.

The step 417, performed by the processor 205 of the server 103 executing the SLMC software application 233 and described hereinafter in more detail with reference to FIG. 6, determines the Mobile terminal hazard velocity (MTHV) and the hazard rating at the Mobile terminal location (MTL), and control then follows an arrow 418 from the step 417 to a step 419. The step 419, performed by the processor 269 of the mobile terminal 111 executing the operating system 268, described hereinafter in more detail under the sub-heading “Determination of the Static Risk Buffer Distance (SRBD)”, determines the Static risk buffer distance (SRBD) for the mobile terminal 111, and control then follows an arrow 420 to a step 421. The step 421, performed by the processor 269 of the mobile terminal 111 executing the operating system 268, described hereinafter in more detail under the sub-heading “Determination of the Dynamic Risk Buffer Distance (MRBD)”, determines the Dynamic risk buffer distance (DRBD) for the mobile terminal 111, and control then follows an arrow 422 to a step 423.

The step 423, performed by the processor 269 of the mobile terminal 111 executing the operating system 268, determines the Functionality mode control signal (FMCS) and sends the signal to the mobile terminal, and control then follows an arrow 424 to a step 425. If the MTL of the MT is at a distance from the boundary between the neighbouring hazard area and the inherently hazardous area which is greater than the Static Risk Buffer Distance (SRBD) and greater than the Dynamic Risk Buffer Distance (MRBD) then the step 423 sends a Functionality Mode Control Signal (FMCS) to the MT for setting the functionality of the MT to Full functionality mode (FFM). If however the MTL of the MT is at a distance from the boundary between the neighbouring hazard area and the inherently hazardous area which is less than the Static Risk Buffer Distance (SRBD) and less than the Dynamic Risk Buffer Distance (MRBD) then the step 423 sends a Functionality Mode Control Signal (FMCS) to the MT for setting the functionality of the MT to Limited functionality mode (LFM).

The step 425, performed by the processor 269 of the mobile terminal 111 executing the operating system 268, directs the operating system 268 of the mobile terminal to adopt the appropriate functionality mode, ie either the Full functionality mode (FFM) or the Limited functionality mode (LFM). Control then follows an arrow 426 back to the step 401, and this completes the current polling cycle taking an average Polling cycle time (PCT) to complete the entire cycle.

FIG. 5A illustrates an example of a map overlay 500 depicting a region in which the disclosed SLMC arrangement can be used to control functionality of a mobile terminal. The map overlay 500 depicts a segment of road 506 bounded by two sides 502, 504 and two ends 505, 505. A sidewalk 509 abuts the road 506 on the left-hand side. A sidewalk 510 abuts the road 506 on the right-hand side.

FIG. 7 shows the map overlay of FIG. 5 overlaid with example hazard ratings and buffer distances for the sake of illustration. A dotted ellipse 703 contains a first series of hazard ratings 10.0, 9.0, 8.1, 7.3, and 6.6. The hazard rating “10” is an Inherent hazard rating (IHR) that is a quantitative measure of the danger associated with the location upon which the rating “10” is shown within the Inherently hazardous area (IHA) which is the road 506.

The hazard ratings 9.0, 8.1, 7.3, and 6.6 are Neighbouring hazard ratings (NHR) that are quantitative measures of the danger associated with the locations upon which the ratings “9.0, 8.1, 7.3, and 6.6” are shown within the Neighbouring hazardous area (NHA) which is the sidewalk 509. The effect of a Neighbouring hazard rating attenuation factor (NHRAF) of 10% as an example is shown in the hazard ratings 10.0, 9.0, 8.1, 7.3, 6.6 which are seen to reduce in 10% steps with increasing distance Dh from the boundary 502 between the Neighbouring hazardous area (NHA) ie the sidewalk 509 and the Inherently hazardous area (IHA) ie the road 506. Accordingly, having regard to the dotted ellipse 703 an NHR of 9.0 applies when the Mobile Terminal Location (MTL) of the MT is at a distance Dh′ (depicted by a dotted boundary 706) from the boundary 502, an NHR of 8.1 applies when the MTL of the MT is at a distance Dh 2 (depicted by a dotted boundary 705) from the boundary 502, an NHR of 7.3 applies when the MTL of the MT is at a distance Dh 3 (depicted by a dotted boundary 704) from the boundary 502, and an NHR of 6.6 applies when the MTL of the MT is at a distance Dh 4 (depicted by a boundary 508) from the boundary 502.

A dotted ellipse 702 contains a second series of hazard ratings 5.0, 4.5, 4.1, 3.7 and 3.3. The hazard rating “5” is an Inherent hazard rating (IHR) that is a quantitative measure of the danger associated with the location upon which the rating “5” is shown within the Inherently hazardous area (IHA) which is the road 506. Accordingly, having regard to the dotted ellipse 702 an NHR of 4.5 applies when the MTL of the MT is at the distance Dh′ (depicted by the dotted boundary 706) from the boundary 502, an NHR of 4.1 applies when the MTL of the MT is at the distance Dh 2 (depicted by the dotted boundary 705) from the boundary 502, an NHR of 3.7 applies when the MTL of the MT is at the distance Dh 4 (depicted by the dotted boundary 704) from the boundary 502, and an NHR of 3.3 applies when the MTL of the MT is at the distance Dh 4 (depicted by the boundary 508) from the boundary 502.

The hazard ratings 4.5, 4.1, 3.7, and 3.3 are Neighbouring hazard ratings (NHR) that are quantitative measures of the danger associated with the locations upon which the ratings “4.5, 4.1, 3.7, and 3.3” are shown within the Neighbouring hazardous area (NHA) which is the sidewalk 509. The effect of a Neighbouring hazard rating attenuation factor (NHRAF) of 10% as an example is shown in the hazard ratings 5.0, 4.5, 4.1, 3.7 and 3.3 which are seen to reduce in 10% steps with increasing distance Dh from the boundary 502 between the Neighbouring hazardous area (NHA) ie the sidewalk 509 and the Inherently hazardous area (IHA) ie the road 506.

FIG. 5B shows the map overlay of FIG. 5A overlaid with mobile terminals and buffer distance markings. The road 506 is an Inherently hazardous area (IHA), and the pavements 509, 510 are Neighbouring hazardous areas (NHA).

Mobile terminals are located as depicted by reference numerals 516 (with Mobile Terminal Velocity (MTV) 517), 523 (with Mobile Terminal Velocity (MTV) equal to zero, ie this mobile terminal is stationary), 518 (with Mobile Terminal Velocity (MTV) 519), 514 (with Mobile Terminal Velocity (MTV) 515), 520 (with Mobile Terminal Velocity (MTV) 521), and 522 (with Mobile Terminal Velocity (MTV) equal to zero).

The MT 516 has a Mobile Terminal Velocity (MTV) depicted by an arrow 517. This vector resolves into (i) a Mobile terminal hazard velocity (MTHV) 529 which is the component of the Mobile Terminal Velocity (MTV) depicted by an arrow 517 towards the associated Inherently hazardous area (IHA) 506, and (ii) a velocity component 528 which is substantially parallel to the boundary 504 between the Inherently hazardous area (IHA) 506 and the Neighbouring hazardous area (NHA) 510. The Mobile terminal hazard velocity (MTHV) 529 indicates how rapidly the terminal 516 is approaching the Inherently hazardous area (IHA) 506.

The Mobile Terminal Hazard Distance (MTHD) for the MT 522, which is the distance of the location of MT 522 from the boundary 502 between the Neighbouring hazardous area (NHA) 509 and the Inherently hazardous area (IHA) 506, can be established by describing a circle 527 centred upon the Mobile Terminal Location (MTL) of the MT 522 which is tangential at a point 530 to the boundary 502 of the Inherently hazardous area (IHA) 506. The Mobile Terminal Location (MTL) 522 of the MT 522 and the MT 522 itself are co-located at 522. The radius of this circle 527 is the Mobile Terminal Hazard Distance (MTHD). The location 530 of the tangent is the location of the Inherently hazardous area (IHA) 506 which is closest to the Mobile Terminal Location (MTL) of the MT 522.

### Determination of the Static Risk Buffer Distance (SRBD)

A Static risk buffer distance (SRBD) 512, depicted by dotted arrows 525 and 525′, is the minimum distance (Mobile Terminal Hazard Distance (MTHD)) a stationary MT must be from the boundary between the Neighbouring hazardous area (NHA) and the Inherently hazardous area (IHA) to be considered safe enough to place the MT in full functionality mode. This Static risk buffer distance (SRBD) is determined by determining the distance Dh at which the Neighbouring hazard rating (NHR) which is less than the Acceptable neighbouring hazard rating (ANHR) which is the acceptable level at which it is deemed to be safe enough to provide full functionality to the MT. The ANHR is typically determined empirically based upon reduction of the number of mobile terminal-caused incidents. Once the Acceptable neighbouring hazard rating (ANHR) is specified, the Static risk buffer distance (SRBD) can be simply read off a lookup table containing location-based hazard ratings such as those illustrated in FIG. 7.

### Determination of the Dynamic Risk Buffer Distance (DRBD)

A Dynamic risk buffer distance (DRBD) 513, depicted by dotted arrows 524 and 524′, is the minimum distance (Mobile Terminal Hazard Distance (MTHD)) at which a moving MT must be (while moving towards the inherently hazardous area at a Mobile terminal hazard velocity (MTHV)) from the boundary between the Neighbouring hazardous area (NHA) and the Inherently hazardous area (IHA) to be considered safe enough to place the MT in full functionality mode. One consideration is that the SLMC system updates the functional mode of the mobile terminal once each Polling Cycle Time (PCT). Accordingly, the Dynamic risk buffer distance (DRBD) should be sufficient to ensure that the moving MT is safe enough to place the MT in full functionality mode for at least one, and preferably two or more Polling Cycle Times (PCT) to allow a transition to Limited functionality mode (LFM) while the location of the MT still has a Neighbouring hazard rating (NHR) which is less than the Acceptable neighbouring hazard rating (ANHR). Accordingly, the Dynamic risk buffer distance (DRBD) can be determined by (a) determining the Mobile terminal hazard velocity distance (MTHVD) which is the distance travelled by the MT, moving at Mobile terminal hazard velocity (MTHV) for N Polling Cycle Times (PCT) where N>=2, and adding this to the Static risk buffer distance (SRBD).

FIG. 6 is a flow chart on one example of a method 600 for performing the step 317 in FIG. 3 or the step 417 in FIG. 4. Control follows the arrow 416 from the step 415 in FIG. 4 to a step 601. The process 600 commences with the step 601, performed by the processor 205 of the server 103 executing the SLMC software application 233, which identifies the nearest Inherently hazardous area (IHA) (eg the road 506 in FIG. 5A). Control then follows an arrow 602 to a step 603. The step 603, performed by the processor 205 of the server 103 executing the SLMC software application 233, determines the location of the point of the identified Inherently hazardous area (IHA) closest to the Mobile Terminal Location (MTL). As previously described with regard to FIG. 5B this can be done by describing the circle 527 centred upon the Mobile Terminal Location (MTL) of the MT 522 which is tangential to the boundary 502 of the Inherently hazardous area (IHA) 506. The radius of this circle is the Mobile Terminal Hazard Distance (MTHD). The location of the tangent is the location of the point of the Inherently hazardous area (IHA) 506 which is closest to the Mobile Terminal Location (MTL) of the MT 527.

Control then follows an arrow 604 from the step 603 to a step 605. The step 605, performed by the processor 205 of the server 103 executing the SLMC software application 233, determines the Inherent hazard rating (IHR) at the location of the Inherently hazardous area (IHA) 506 which is closest to the Mobile Terminal Location (MTL) of the MT 527. Control then follows an arrow 606 from the step 605 to a step 607. The step 607, performed by the processor 205 of the server 103 executing the SLMC software application 233, determines the Mobile terminal hazard velocity (MTHV) of the MT towards the location of the Inherently hazardous area (IHA) 506 which is closest to the Mobile Terminal Location (MTL) of the MT 527. Control then follows an arrow 608 from the step 607 to a step 609. The step 609, performed by the processor 205 of the server 103 executing the SLMC software application 233, communicates the Mobile terminal hazard velocity (MTHV) and the Inherent hazard rating (IHR) at the location of the Inherently hazardous area (IHA) 506 which is closest to the Mobile Terminal Location (MTL) of the MT 527 to the MT. Control then follows an arrow 418 from the step 609 to the step 419 in FIG. 4.

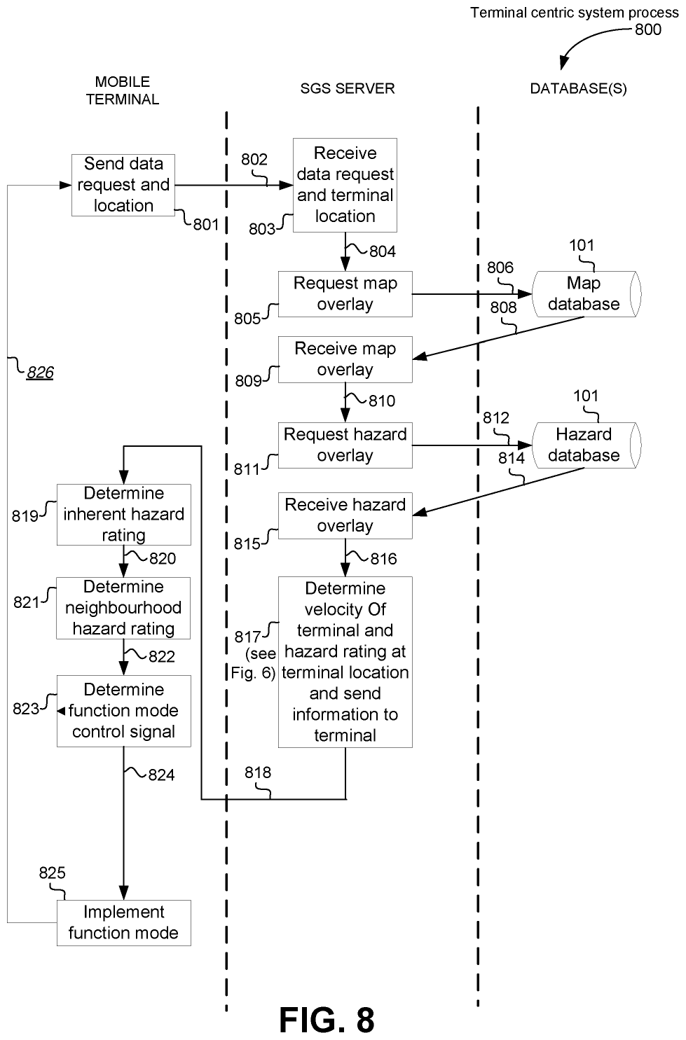

FIG. 8 is a flow diagram of one example of a mobile terminal-centric method of performing the second SLMS arrangement according to the present disclosure. The process 800 commences a current polling cycle with a step 801, performed by the processor 269 of the mobile terminal 111 executing the operating system 268, which determines the Mobile terminal location (MTL) using an onboard GPS chip set 272 to communicate with a global positioning system satellite, for example, and communicates this MTL together with a request for data, to the SGS server 103. Control then follows an arrow 802 from the step 801 to a step 803, performed by the processor 205 of the server 103 executing the SLMC software application 233. The step 803, performed by the processor 205 of the server 103 executing the SLMC software application 233, receives the MTL and the data request, and control then follows an arrow 804 from the step 803 to a step 805.

The step 805, performed by the processor 205 of the server 103 executing the SLMC software application 233, requests as depicted by an arrow 806, a map overlay (described hereinafter in more detail with reference to FIG. 5) from the database 101. The database 101 then sends, as depicted by an arrow 808, the requested map overlay to a step 809. The step 809, performed by the processor 205 of the server 103 executing the SLMC software application 233, receives the map overlay, and control then follows an arrow 810 from the step 809 to a step 811. The step 811, performed by the processor 205 of the server 103 executing the SLMC software application 233, requests, as depicted by an arrow 812, a hazard overlay (described hereinafter in more detail with reference to FIG. 7) from the database 101. The database 101 then sends, as depicted by an arrow 814, the requested hazard overlay to a step 815. The step 815, performed by the processor 205 of the server 103 executing the SLMC software application 233, receives the hazard overlay, and control then follows an arrow 816 from the step 815 to a step 817.

The step 817, performed by the processor 205 of the server 103 executing the SLMC software application 233 and described in more detail with reference to FIG. 6, determines the Mobile terminal hazard velocity (MTHV) and the hazard rating at the Mobile terminal location (MTL), and control then follows an arrow 818 from the step 817 to a step 819. The step 819, performed by the processor 269 of the mobile terminal 111 executing the operating system 268, determines the Inherent hazard rating (IHR) at the location of the point of the Inherently hazardous area (IHA) 506 which is closest to the Mobile Terminal Location (MTL) of the MT 527. Control then follows an arrow 820 to a step 821. The step 821, performed by the processor 269 of the mobile terminal 111 executing the operating system 268, determines the Neighbouring hazard rating (NHR) using for example the lookup table containing location-based hazard ratings such as those illustrated in FIG. 7 indexed by the Mobile Terminal Location (MTL).

Control then follows an arrow 822 to a step 823. The step 823, performed by the processor 269 of the mobile terminal 111 executing the operating system 268, determines the Functionality mode control signal (FMCS). If the MTL of the MT is at a distance from the boundary between the neighbouring hazard area and the inherently hazardous area such that the Neighbouring hazard rating (NHR) is less than the Acceptable neighbouring hazard rating (ANHR) then the step 823 sends a Functionality Mode Control Signal (FMCS) to the MT for setting the functionality of the MT to Full functionality mode (FFM). If however the MTL of the MT is at a distance from the boundary between the neighbouring hazard area and the inherently hazardous area such that the Neighbouring hazard rating (NHR) is greater than the Acceptable neighbouring hazard rating (ANHR) then the step 823 sends a Functionality Mode Control Signal (FMCS) to the MT for setting the functionality of the MT to Limited functionality mode (LFM).

Control then follows an arrow 824 to a step 825. The step 825, performed by the processor 269 of the mobile terminal 111 executing the operating system 268, directs the operating system 268 of the mobile terminal to adopt the appropriate functionality mode, ie either the Full functionality mode (FFM) or the Limited functionality mode (LFM). Control then follows an arrow 826 back to the step 801, and this completes the current polling cycle taking an average Polling cycle time (PCT) to complete the entire cycle.

In another preferred embodiment of a SLMC arrangement, the system is configured to selectively limit the functionality of a mobile terminal in the form a smartphone having some operating system such a Android™ or iOS™. The mobile terminal MT has various functionality that may include receiving or initiating telephone calls, sending or receiving text messages, operation of local or connected application software such as social media apps or an internet browsers amongst very many others, GPS location hardware and software. The operation of the mobile terminal such as terminal 111 is controlled by the smartphone operating system (eg 268).

The SLMC arrangement of this embodiment also includes a server 103 having a processor for executing a computer executable software program, and one or more mobile terminals MT 111 each having a processor for executing a computer executable software program. The server 103 and the one or more mobile terminals MT 111 communicate over a communications network as described above and the server 103 and the one or more mobile terminals MT 111 communicate over a communications network such as a cellular telephone network for example.

In operation, the mobile terminal 111 is configured to selectively limit the functionality of the mobile terminal MT 111 by determining a mobile terminal location MTL of the mobile terminal MT 111 and a hazard rating at the location MTL of the mobile terminal MT 111 whereby the mobile terminal MT 111 is enabled to operate in a full functionality mode if the determined hazard rating is at or less than an acceptable level and enabling the mobile terminal MT 111 to operate in a limited functionality mode if the determined hazard rating is above the acceptable level.

Furthermore, in this preferred embodiment, selectively limiting functionality of the mobile terminal MT is achieved by hard-wiring the mobile terminal 111 operating system 268 to continually operate during operation of the mobile terminal MT 111, and this preferably achieved at the operating system OEM level. That is, the SLMC is not able to be disabled during operation of the mobile terminal 111. It will be appreciated that a smartphone 111 can be configured to operate the present method when updating the smartphone 111 operating system 268. Alternatively, selectively limiting functionality of the mobile terminal MT is achieved by physically attaching or wirelessly connecting a mobile terminal function limiting module 285 integral or associated with the mobile terminal such that the module causes operation of the SLMC when the mobile terminal MT is operational. Module 285 is shown in FIG. 1 as an addition to the system which can be integral within smartphone 111 or otherwise connected to it whereby it constantly engages the method of the preferred embodiments in a hard wired manner.

In operation of the SLMC on the smartphone 111 selectively limiting functionality of the mobile terminal MT disengages when the smartphone 111 is connected to a vehicle communications system and the mobile terminal MT is disposed in a vehicle mobile terminal mount, caddy or cradle. In this way, there can be some assurance the driver will not be holding smartphone 111. The state of additional vehicle sensors such as seat load or door sensors can also be engaged in the SLMC so that in response to the door or seat sensor (for example, also may include optical driver sensors or monitoring devices) indicating a driver is in a vehicle, the SLMC will not allow full functionality of the smartphone 111 until it is both in communication with a vehicle communication systems (eg by wire or wirelessly) and physically located in a mount device. This last condition may be optional is desired.

The SLMC can be further configured to operate in circumstance where smartphone 111 has lost or is not in communication with the server 103 via the communications network. In such cases, the selective limiting of functionality of the mobile terminal MT 111 is configured to engage or disengage based on a current location of the mobile terminal relative to a hazard or danger zone, or based on a predicted location of the mobile terminal for example as based on a derived location history (including spatial location, directional headings and sppeds) of the smartphone 111. For example, times a user is in a work routine and typical approximate locations including in pedestrian or vehicle danger or hazard zones, in particular where a route can be predicted from present traffic conditions (eg using Google Maps™ data) corresponding to the mobile terminal location (derived by cellular telephone transceivers, GPS, local VVi-Fi or other source). Yet further, messaging can be automatically instigated to a predetermined address to indicate the mobile terminal entering and/or exiting a hazardous area or zone.

It can be seen that there is advantageously provided a system, method and apparatus that can be hard-wired (ie cannot be disabled by a user) into a smartphone 111 or other mobile terminal so that functionality is disabled under hazard conditions such as location and most advantageously dependent on mobile terminal velocity and, as desired, the system can engage specific or complete mobile terminal functionality subject to location and/or hazard rating of the mobile terminal. The system is suitable for pedestrians and cyclists, the latter having hazards being velocity dependent but in either case, functionality of the mobile terminal can be limited if within some predetermined distance of a hazard or hazard area/zone. Importantly, server 103 and/or mobile terminal 111 can include a record or log of functionality of the mobile terminal including operation providing accurate records in the event of an accident or traffic violation, or if used for other reasons. Further, the system can re-instate or limit mobile terminal functionality when departing or entering a hazard zone respectively.

### INDUSTRIAL APPLICABILITY

The arrangements described are applicable to the computer and data processing industries and particularly for the industries related to mobile communications.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method of selectively limiting functionality of a mobile terminal MT, the method comprising the steps of:
determining a mobile terminal location MTL of the mobile terminal MT;
determining a hazard rating at the location MTL of the mobile terminal MT;
enabling the mobile terminal MT to operate in a full functionality mode if the determined hazard rating is at or less than an acceptable level; and
enabling the mobile terminal MT to operate in a limited functionality mode if the determined hazard rating is above the acceptable level.

2. The method according to claim 1, wherein:
the step of determining a mobile terminal location MTL of the mobile terminal MT further comprises the step of requesting a map overlay from a map database; and wherein:
the step of determining a hazard rating at the location MTL of the mobile terminal MT further comprises the step of requesting a hazard overlay from a hazard database.

3. The method according to claim 2, wherein the step of determining the hazard rating at the location MTL of the mobile terminal MT comprises the steps of:
identifying the closest inherently hazardous area IHA to the mobile terminal MT; and
if the mobile terminal location MTL is inside the identified inherently hazardous area IHA, specifying the hazard rating at the location MTL of the mobile terminal MT to be above the acceptable level.

4. The method according to claim 2, wherein the step of determining the hazard rating at the location MTL of the mobile terminal MT comprises the steps of:
identifying the closest inherently hazardous area IHA to the mobile terminal MT;
determining a location of the closest point of the identified inherently hazardous area IHA to the mobile terminal Location (MTL);
determining an inherent hazard rating IHR at the location of the closest point of the inherently hazardous area to the mobile terminal Location (MTL);
determining a mobile terminal hazard velocity (MTHV) of the mobile terminal MT towards the location of the closest point of the inherently hazardous area to the mobile terminal Location (MTL); and
determining the hazard rating at the location MTL of the mobile terminal MT dependent upon the location MTL of the mobile terminal MT and the mobile terminal hazard velocity (MTHV) of the mobile terminal MT.

5. A method according to claim 1 wherein the step of selectively limiting functionality of the mobile terminal MT is: (i) hard-wired into the mobile terminal to continually operate during operation of the mobile terminal MT; or (ii) is disposed on mobile terminal function limiting module integral or associated with the mobile terminal such that the module causes operation of the method steps when the mobile terminal MT is operational.

6. A method according to claim 1 or 5 wherein the selective limiting of functionality of the mobile terminal MT is configured to disengage when the mobile terminal MT is connected to a vehicle communications system and/or the mobile terminal MT is disposed in a vehicle mobile terminal mount, caddy or cradle and connected to a vehicle communication system via the mount, caddy or cradle.

7. A method according to claim 1 or 5 wherein the step of selectively limiting functionality of the mobile terminal MT is engaged in response to communication from a vehicle communication system of a vehicle operator at controls of the vehicle and the mobile terminal MT is not either or both disposed within a mobile terminal mount, caddy or cradle and connected to the vehicle communication system.

8. A method according to any one of claims 5 to 7 wherein when the mobile terminal MT has lost or is not in communication with the server via the communications network, the step of selectively limiting functionality of the mobile terminal MT is configured to engage or disengage based on a current location of the mobile terminal MT, or based on a predicted location of the mobile terminal MT.

9. A method according to claim 8 wherein the predicted location of the mobile terminal MT is predetermined or based on a derived location history of the mobile terminal MT.

10. A method according to any one of claims 5 to 9 wherein functionality of the mobile terminal includes telephone calls, messaging, email, one or more predetermined application software programs loaded on the mobile terminal MT.

11. A system for selectively limiting functionality of a mobile terminal MT, the system comprising:
a server having a processor for executing a computer executable software program;
one or more mobile terminals MT each having a processor for executing a computer executable software program; wherein
the server and the one or more mobile terminals MT communicate over a communications network; and wherein the server and the one or more mobile terminals MT communicating over a communications network perform a method of selectively limiting functionality of the mobile terminal MT, the method comprising the steps of:
determining a mobile terminal location MTL of the mobile terminal MT;
determining a hazard rating at the location MTL of the mobile terminal MT;
enabling the mobile terminal MT to operate in a full functionality mode if the determined hazard rating is at or less than an acceptable level; and
enabling the mobile terminal MT to operate in a limited functionality mode if the determined hazard rating is above the acceptable level.

12. A system according to claim 11 wherein the method of selectively limiting functionality of the mobile terminal MT is: (i) hard-wired into the mobile terminal to continually operate during operation of the mobile terminal MT; or (ii) is disposed on mobile terminal function limiting module integral or associated with the mobile terminal such that the module causes operation of the method steps when the mobile terminal MT is operational.

13. A system according to claim 11 or 12 wherein the method of selectively limiting functionality of the mobile terminal MT is configured to disengage when the mobile terminal MT is connected to a vehicle communications system and/or the mobile terminal MT is disposed in a vehicle mobile terminal mount, caddy or cradle and connected to a vehicle communication system via the mount, caddy or cradle.

14. A system according to claim 11 or 12 wherein the method of selectively limiting functionality of the mobile terminal MT is engaged in response to communication from a vehicle communication system of a vehicle operator at controls of the vehicle and the mobile terminal MT is not either or both disposed within a mobile terminal mount, caddy or cradle and connected to the vehicle communication system.

15. A system according to any one of claims 11 to 14 wherein when the mobile terminal has lost or is not in communication with the server via the communications network, the method of selectively limiting functionality of the mobile terminal MT is configured to engage or disengage based on a current location of the mobile terminal, or based on a predicted location of the mobile terminal.

16. A system according to claim 15 wherein the predicted location of the mobile terminal MT is predetermined or based on a derived location history of the mobile terminal MT.

17. A system according to any one of claims 11 to 16 wherein functionality of the mobile terminal includes telephone calls, messaging, email, one or more predetermined application software programs loaded on the mobile terminal MT.

18. A computer executable software program for directing one or more processors to perform a perform a method of selectively limiting functionality of the mobile terminal MT, the method comprising the steps of:
determining a mobile terminal location MTL of the mobile terminal MT;
determining a hazard rating at the location MTL of the mobile terminal MT;
enabling the mobile terminal MT to operate in a full functionality mode if the determined hazard rating is at or less than an acceptable level; and
enabling the mobile terminal MT to operate in a limited functionality mode if the determined hazard rating is above the acceptable level.
